(19) United States
(12) Patent Application Publication
(10) Pub. No.: US 2010/0132156 A1
(43) Pub. Date: Jun. 3, 2010

(54) CASTOR WHEEL ASSEMBLY

(76) Inventor: Ronald Barry Morris, Spencer (AU)

Correspondence Address: LADAS & PARRY LLP, 224 SOUTH MICHIGAN AVENUE, SUITE 1600, CHICAGO, IL, 60604, US

(21) Appl. No.: 12/063,320

(22) PCT Filed: Aug. 11, 2006
(86) PCT No.: PCT/AU06/01152

§ 371 Date: Jul. 31, 2008

(30) Foreign Application Priority Data
Aug. 11, 2005 (AU) 2005904331
Mar. 13, 2006 (AU) 2006901271

(51) Int. Cl. B60B 33/04; B60B 33/00

(52) U.S. Cl. 16/19; 16/18 R

(57) ABSTRACT

Castor wheel assembly including a castor pin having a castor axis; a yoke mounted to the castor pin—and rotatable about a yoke axis; a castor wheel rotatably mounted to the yoke about a wheel axis; and a gradient device disposed between the castor pin and the yoke. The gradient device is operative to allow angular displacement of the yoke axis relative to the castor axis.

### FIELD OF THE INVENTION

The present invention relates to a castor wheel assembly as well as an apparatus having such an assembly. The castor wheel assembly of the invention may be attached to any apparatus commonly provided with castor wheels.

### BACKGROUND OF THE INVENTION

Castor wheels are commonly used where it is desirable to be able to push along and manoeuvre apparatus. However, apparatus fitted with castor wheels can be difficult to steer and castor wheels have a tendency to deflect from the path of travel, particularly on rough or uneven surfaces which can exacerbate steering problems. The lack of suspension on uneven surfaces adds to the problems associated with castor wheels. Most people have experienced this problem with shopping trolleys.

The use of castor wheels on shopping trolleys also presents another problem. When shopping trolleys are swung around or steered sharply around a corner, the front castor wheels swing outwardly to allow for the change in direction of travel. Accordingly, the support provided by the front castor wheels shifts toward the outward side of the trolley at this time and the trolley becomes more susceptable to tipping over on its opposite side in the event excessive weight is exerted on the opposite side as can occur when an unrestrained child is carried in the trolley. It has been reported that a frightening number of children are injured each year due to shopping trolley accidents, a substantial number of which resulted in head and facial injuries.

There is, therefore, a need to improve the steerability of apparatus such as shopping trolleys, which are provided with castor wheels, and to reduce the possibility of shopping trolleys or other such apparatus tipping over in use.

### SUMMARY OF THE INVENTION

Disclosed is a castor wheel assembly comprising a castor pin having a castor axis; a yoke mounted to the castor pin and rotatable about a yoke axis; a castor wheel rotatably mounted to the yoke about a wheel axis; and a gradient device disposed between the castor pin and the yoke, the gradient device operative to allow angular displacement of the yoke axis relative to the castor axis.

In one form the direction of the angular displacement of the yoke axis relative to the castor axis is variable with respect to the castor pin.

In one form the direction of angular displacement of the yoke axis with respect to the castor axis is dependent upon the direction in which the castor wheel is moving.

In one form the gradient device is operative to allow the rake of the yoke axis with respect to the direction of movement of the castor wheel to be consistent within a predetermined angular range throughout the rotation of the yoke about the yoke axis.

In one form the gradient device is arranged to restrict the angular displacement of the yoke axis relative to the castor axis to occur within a plurality of predetermined planes containing the castor axis. In one form the planes are angularly spaced about the castor axis by approximately 45°.

In one form the gradient device comprises an upper section mounted to the castor pin, the upper section having an upper protrusion extending downwardly from the upper section; and a lower section mounted to the yoke, the lower section having a lower protrusion extending upwardly from the lower section; wherein in use the upper protrusion and the lower protrusion interact.

In one form one of the upper protrusion and the lower protrusion comprises a bearing surface and the other of the upper and lower protrusion comprises a complementary surface.

In one form the bearing surface has a hemispherical shape.

In one form the bearing surface comprises a bolt with a curved head and the complementary surface comprises a bolt with a flat head.

In one form, the gradient device comprises an upper section mounted to the castor pin; a yoke section mounted to the yoke; and, a coupler connecting the pin section and the yoke section, wherein the coupler is operative to allow relative movement of the pin section and the yoke section.

In one form the coupler comprises a biasing means operative to bias the sections into a first position, and a threshold loading is required to overcome the bias of the biasing means to allow the sections to move from the first position so as to cause angular displacement of the yoke axis relative to the castor axis.

In a second embodiment, disclosed is a castor wheel assembly comprising: a chassis adapted to be rotatably mounted to an apparatus by means of a castor wheel axle; and, a support wheel mounted to the chassis by means of a support wheel axle, the support wheel being positioned to be unable to contact the castor wheel in use; wherein the castor wheel leads the support wheel when the castor wheel assembly is rolled along a surface on the castor wheel and support wheel and wherein the retaining pin and the castor pin are substantially vertical in orientation.

### BRIEF DESCRIPTION OF THE ACCOMPANYING DRAWINGS

Notwithstanding any other forms that may fall within the scope of the castor wheel assembly as defined in the summary, specific embodiments of the method and material will now be described, by way of example only, with reference to the accompanying drawings in which:

FIG. 1 is a front elevation view of the gradient device of one embodiment of the castor wheel assembly;

FIG. 2 is a cross-sectional side elevation view of the gradient device of FIG. 3 in a first position;

FIG. 3 is a cross-sectional side elevation view of the gradient device of FIG. 3 with compression spring;

FIG. 4 is a top plan view of the gradient device of FIG. 3 showing the planes of angular displacement;

FIG. 5 is a side elevation view of a castor wheel assembly of a second embodiment of the invention;

FIG. 6 is a top plan view of the castor wheel assembly shown in FIG. 5;

FIG. 7 is a partial base view of the castor wheel assembly shown in FIG. 5 in use;

FIG. 8 is a partial base view of the castor wheel assembly shown in FIG. 5 in use;

FIG. 9 is a partial base view of the castor wheel assembly shown in FIG. 5 in use;

FIG. 10 is a cross-sectional side elevation view of a gradient device of a third embodiment of the invention in a first position;

FIG. 11 is a side elevation view of the gradient device in use.

### DETAILED DESCRIPTION OF PREFERRED EMBODIMENTS OF THE INVENTION

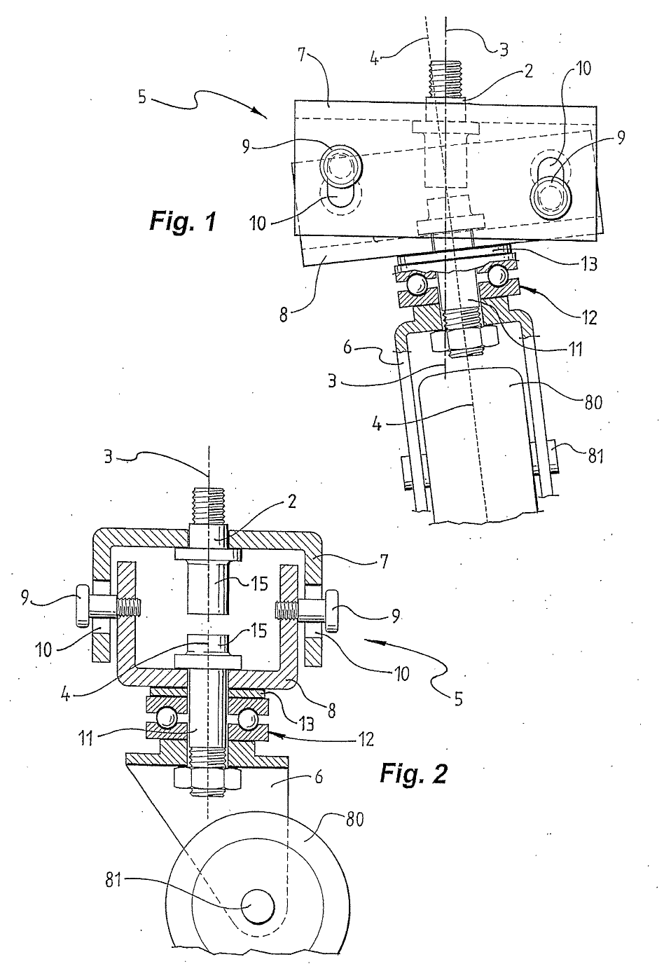

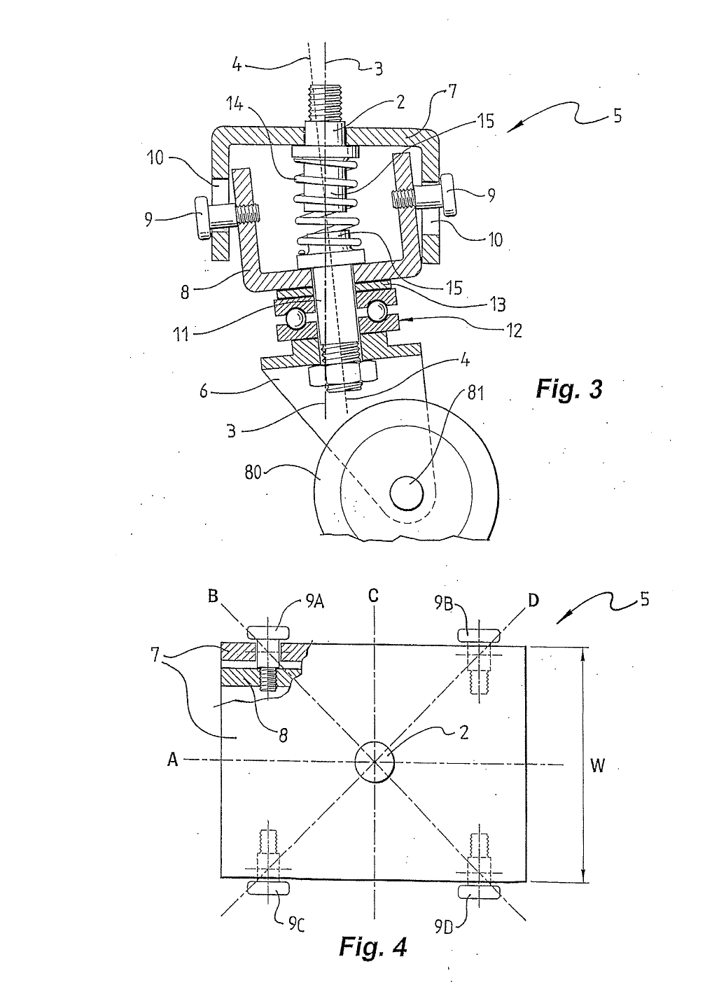

A first embodiment of the castor assembly is shown in FIGS. 1-3. The castor assembly 1 shown in FIGS. 1-3 comprises a castor pin 2 which is adapted to be attached to an apparatus 20 (shown in FIGS. 11 and 12) such as a shopping trolley or other item supported on castor wheels. The castor pin 2 has a longitudinal castor axis 3.

A yoke 6 is rotatably attached to the castor pin 2. The yoke 6 is rotatable about a longitudinal yoke axis 4. A castor wheel 80 is attached to the yoke by means of an axle 81.

A gradient device 5 is disposed between the castor pin 2 and the yoke. The gradient device 5 comprises upper section 7 and lower section 8. Upper section 7 is adapted to be attached to castor pin 2. Lower section 8 is adapted to be attached to the yoke by means of a yoke pin 11, yoke attachment means 12. A washer 13 is positioned between yoke attachment means 12 and lower section 8. The upper section 7 and lower section 8 comprise U-shaped brackets which are adapted such that lower section 8 is disposed upright and upper section 7 is inverted and disposed over lower section 8.

Lower section 8 includes one or more retaining bolts 9 which extend through elongated apertures 10 in upper section 7. Elongated aperture 10 is longitudinally elongate. As a result upper section 7 and lower section 8 are attached such that they are moveable relative to one another. The two retaining bolts 9 and two elongated apertures 10 shown in FIG. 1 allow upper section 7 and lower section 8 to incline relative to one another.

The gradient device 5 further comprises a biasing means operative to bias the sections into a first position (shown in FIG. 2). A threshold loading is required to overcome the bias of the biasing means to allow the upper section 7 and lower section 8 to move from the first position so as to cause angular displacement of the yoke axis 4 relative to the castor axis 3. The threshold loading is preferably the weight of the trolley. In one illustrated form the biasing means comprises a tension spring 14 which is positioned between upper section 7 and lower section 8. The spring 14 is attached to lower section 8 and upper section 7 by means of spring attachment pins 15.

Preferably upper section 7 and lower section 8 are operative to incline relative to one another such that castor axis 3 and yoke axis 4 are angularly displaced between 0° and 25°. Preferably the castor axis 3 is disposed vertically and the yoke axis 4 is operative to incline with respect to the castor axis 3 at an angle of between 0° and 25°. More preferably the yoke axis 4 is operative to incline with respect to the castor axis 3 at an angle of between 5° and 15°. Most preferably the angle between the yoke axis 4 and the castor axis 3 is approximately 7° or 8°.

The gradient device 5 is arranged such that the angular displacement of the yoke axis 4 relative to the castor axis 3 can be varied. That is the angular displacement of the yoke axis 4 relative to the castor axis 3 occurs in different planes depending upon the direction of movement of the castor assembly 1. The angular displacement is restricted to occur within one or more predetermined planes containing the castor axis 3. In one form the planes are angularly spaced about the castor axis 3 by approximately 45°. This is best depicted in FIG. 4 which shows planes A B C and D within which angular displacement can occur.

Angular displacement of the yoke axis 4 relative to the castor axis 3 in plane A requires that retaining bolts 9A and 9C together move upwardly or downwardly relative to the gradient device 5 while retaining bolts 9B and 9D move in the reverse direction, that is upwardly if 9A and 9C move downwardly or downwardly if 9A and 9C move upwardly with respect to gradient device 5. Angular displacement of the yoke axis 4 relative to the castor axis 3 in plane C requires that retaining bolts 9A and 9B together move upwardly or downwardly relative to the gradient device 5 while retaining bolts 9C and 9D move together in the reverse direction with respect to gradient device 5.

Angular displacement of the yoke axis 4 relative to the castor axis 3 in plane B requires that retaining bolt 9A moves upwardly or downwardly relative to the gradient device 5 while retaining bolt 9D moves in the reverse direction with respect to gradient device 5. That is if 9A moves upwardly 9D moves downwardly and vice versa with respect to the gradient device. Retaining bolts 9B and 9C rotate slightly with respect to the gradient device. Similarly angular displacement of the yoke axis 4 relative to the castor axis 3 in plane D requires that retaining bolt 9B moves upwardly or downwardly relative to the gradient device 5 while retaining bolt 9C moves in the reverse direction with respect to gradient device 5. Retaining bolts 9A and 9D rotate slightly with respect to the gradient device.

The angular displacement of the yoke axis 4 with respect to the castor axis 3 is away from the direction in which the castor assembly 1 is moving. That is, if the castor assembly 1 and therefore the apparatus 20 is moving in a direction defined as forward the yoke axis 4 is angled so that the yoke is positioned backward of the castor pin 2 and the yoke axis 4 is angled at approximately 7° with respect to the castor axis 3.

The distance between retaining bolts 9 is the same as the width of upper section 7 as best shown in FIG. 4. As a result the planes of angular displacement A B C and D are set within a square. This allows control of the planes of angular displacement A B C and D so they occur at 45° intervals.

The inclination of the yoke axis 4 relative to the castor axis 3 and resultant off-set of the castor wheel results in a tendency for the castor wheel assembly 1 to be maintained in a resting trailing position. This results in increased fore-and-aft directional stability and increased self-centering action following angular deflection as the apparatus is pushed along.

It can be seen that the angular displacement of castor axis 3 and yoke axis 4 results in the angular displacement of the castor wheel relative to the apparatus.

The gradient device 5 is operative such that when the apparatus reaches a threshold loading and is moving the castor axis 3 and yoke axis 4 are angularly displaced. As a result movement of the apparatus results in greater contact between the castor wheel and the surface (not illustrated) upon which it is rolling. This allows for greater steerability and less deflection from the path of travel of the apparatus.

Further as the castor wheel is operative to rotate about the yoke axis 4 independently of the gradient device 5, changes in direction of the apparatus changes the direction of the angular displacement, maintaining the set-off of the castor wheel relative to the castor pin 2 and thus maintaining the enhanced steerability of the apparatus.

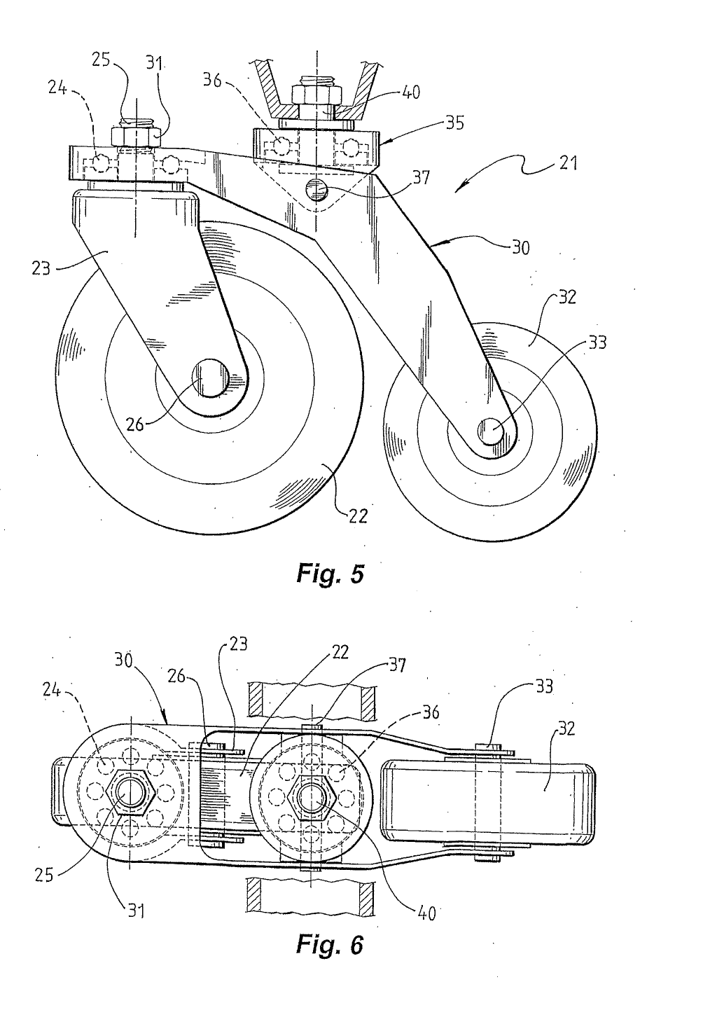

A second embodiment of the invention is shown in FIGS. 5-9. In this embodiment, the castor wheel assembly 21 comprises a castor wheel 22 mounted to a yoke 23 having a castor wheel bearing 24 received on a castor pin 25. Accordingly, castor wheel 22 is readily rotatable about the castor pin 25. The yoke 23 is rotatable about the longitudinal axis of castor pin 25.

The castor wheel 22 is rotatably attached to the yoke 23 by means of a horizontal castor axle 26. The castor wheel 22 is rotatable about the longitudinal axis of the castor axle 26.

The castor pin 25 is secured to a leading end region of a chassis 30 by means of a castor wheel fixing nut 31. A support wheel 32 is attached on a trailing end of chassis by means of horizontal support wheel axle 33. The support wheel 32 is therefore rotatable about the longitudinal axis of support wheel axle 33.

The chassis 30 is attached to a chassis attachment means 35 which has a chassis bearing 36 received on a chassis retaining pin 40. A chassis rocker pin 37 is further attached with chassis 30. Accordingly, the chassis is rotatable about the longitudinal axis of chassis retaining pin 40 and moveable about the longitudinal axis of chassis rocker pin 37.

The support wheel 32 is adapted to provide directional stability. The support wheel 32 is spaced from the castor wheel 22 rearwardly of the chassis retaining pin 40 to enable rotation of the castor wheel 22 about castor pin 25 without contact of the two wheels.

In one form the support wheel 32 can comprise two parallel support wheels. This adds traction to the support wheel 32.

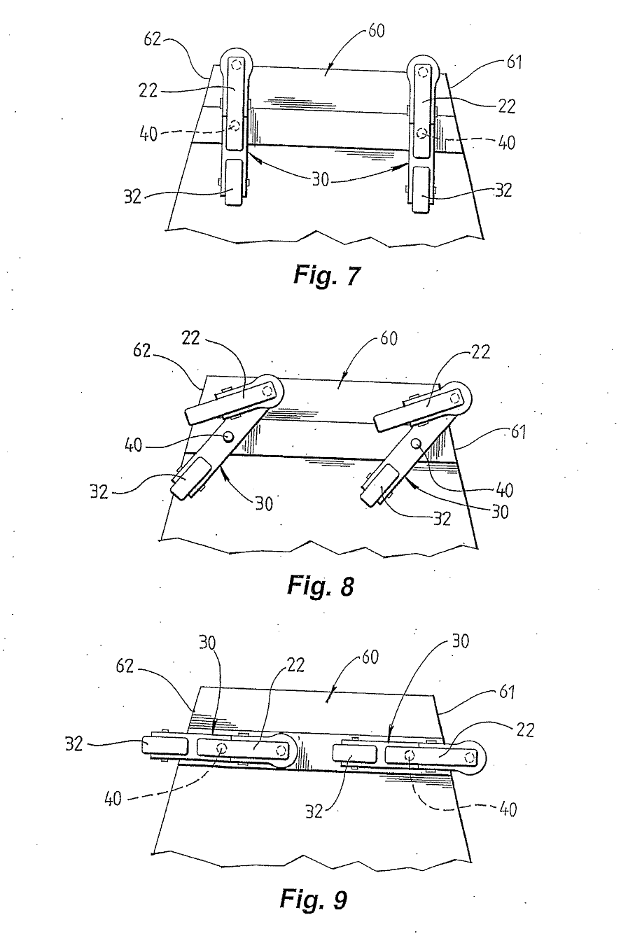

As shown in FIGS. 7 through 9, an additional castor wheel assembly is secured on an opposite side of the front region of the shopping trolley such that both castor wheel assemblies are in alignment as is commonly known.

The relative movement of the castor wheel 22 and the support wheel 32 when the shopping trolley 60 is being manoeuvred in use is illustrated in FIGS. 6 through 8. As indicated in FIG. 7, support wheels 32 of castor wheel assemblies 1 are in alignment with and trail the respective castor wheels 22 when the shopping trolley 60 is pushed in a forward direction. When turning as shown in FIG. 8, in this instance to the right, castor wheel 22 and support wheel 32 rotate about retaining pin 40 causing chassis 20 to swing around and orientate in the direction of travel. As the chassis 20 swings, castor wheels 2 are drawn toward side 61 of shopping trolley 60 so that the support provided by the castor wheels 22 is offset relative to the longitudinal axis of the shopping trolley 60. At the same time, support wheels 32 swing outwardly toward trolley side 62 until each aligns with the corresponding castor wheel 22 upon further manoeuvring of the trolley 60. The support wheels 32 act to support side 62 of the trolley 60 and widen the front wheel base of trolley 60 compared to that if conventional castor wheel assemblies were used.

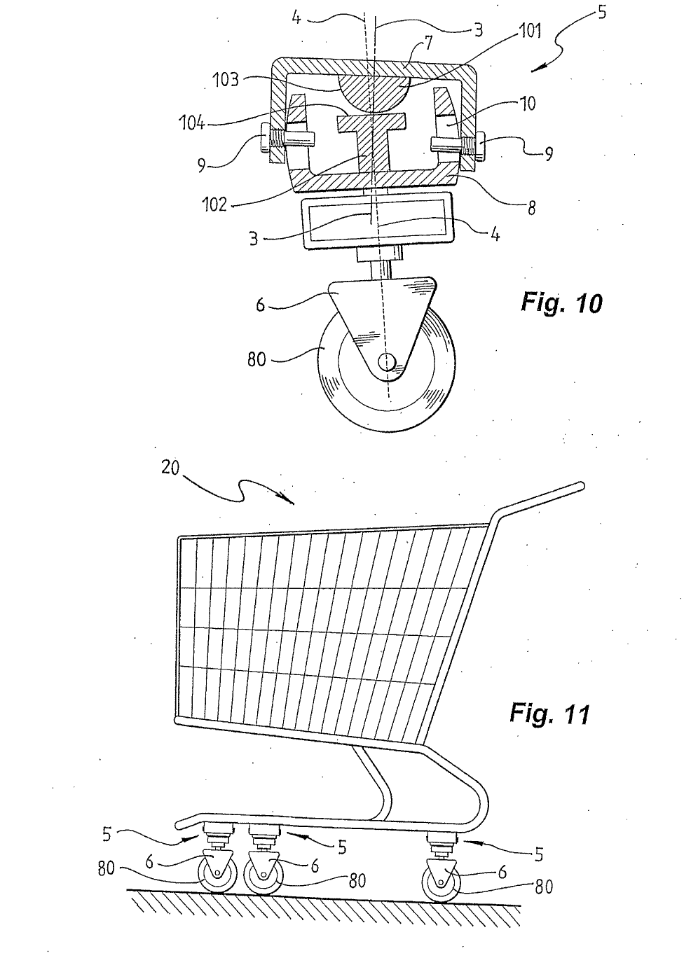

A third embodiment of the castor wheel assembly of the present invention is shown in FIG. 10. FIG. 10 shows gradient device 5 which is disposed between the castor pin (not illustrated) and the yoke 6. The gradient device 5 comprises upper section 7 and lower section 8. Upper section 7 is adapted to be attached to the castor pin. Lower section 8 is adapted to be attached to the yoke by means of a yoke pin (not illustrated).

The upper section 7 and lower section 8 comprise U-shaped brackets which are adapted such that lower section 8 is disposed upright and upper section 7 is inverted and disposed over lower section 8. Upper section 7 includes retaining bolts 9 while lower section 8 includes one or more elongated apertures 10. The elongated apertures are longitudinally elongate. As a result upper section 7 and lower section 8 are attached such that they are adapted to move relative to one another as the retaining bolts 9 move within the elongated apertures 10.

Preferably the castor axis 3 is disposed vertically and the yoke axis 4 is operative to incline with respect to the castor axis 3 at an angle of between 0° and 25°. More preferably the yoke axis 4 is operative to incline with respect to the castor axis 3 at an angle of between 5° and 15°. Most preferably the angle between the yoke axis 4 and the castor axis 3 is approximately 7° or 8°.

The gradient device 5 is arranged such that the angular displacement of the yoke axis 4 relative to the castor axis 3 can be varied. That is the angular displacement of the yoke axis 4 relative to the castor axis 3 occurs in different planes depending upon the direction of movement of the castor assembly 1. The angular displacement is restricted to occur within one or more predetermined planes containing the castor axis 3. In one form the planes are angularly spaced about the castor axis by approximately 45°. This is best depicted in FIG. 4 which shows planes A B C and D within which angular displacement can occur.

Angular displacement of the yoke axis 4 relative to the castor axis 3 in plane B requires that retaining bolt 9A moves upwardly or downwardly relative to the gradient device 5 while retaining bolt 9D moves in the reverse direction with respect to gradient device 5. That is if 9A moves upwardly 9D moves downwardly and vice versa with respect to the gradient device. Retaining bolts 9B and 9C rotate slightly with respect to the gradient device. Similarly angular displacement of the yoke axis 4 relative to the castor axis 3 in plane D requires that retaining bolt 9B moves upwardly or downwardly relative to the gradient device 5 while retaining bolt 9C moves in the reverse direction with respect to gradient device 5. Retaining bolts 9A and 9D rotate slightly with respect to the gradient device.

The angular displacement of the yoke axis 4 with respect to the castor axis 3 is away from the direction in which the castor assembly 1 is moving. That is, if the castor assembly 1 and therefore the apparatus 20 is moving in a direction defined as forward the yoke axis 4 is angled so that the yoke is positioned backward of the castor pin 2 and the yoke axis 4 is angled at approximately 7° with respect to the castor axis 3.

The distance between retaining bolts 9 is the same as the width of upper section 7 as best shown in FIG. 4. As a result the planes of angular displacement A B C and D are set within a square. This allows control of the planes of angular displacement A B C and D so they occur at 45° intervals.

The inclination of the yoke axis 4 relative to the castor axis 3 and resultant off-set of the castor wheel results in a tendency for the castor wheel assembly 1 to be maintained in a resting trailing position. This results in increased fore-and-aft directional stability and increased self-centering action following angular deflection as the apparatus is pushed along.

It can be seen that the angular displacement of castor axis 3 and yoke axis 4 results in the angular displacement of the castor wheel relative to the apparatus.

Further it can be seen that the direction of angular displacement of the yoke axis 4 with respect to the castor axis 3 is dependent upon the direction in which the castor wheel 80 is moving. The direction of angular displacement is away from the direction of movement. The gradient device 5 is operative to allow the yoke axis 4 to be raked backward with respect to the direction of movement of the castor wheel 80. This allows the rake of the yoke axis 4 to be consistent within a predetermined angular range throughout the rotation of the yoke 6 about the yoke axis 4.

Gradient device 5 comprises an upper section 7 mounted to the castor pin and a lower section 8, mounted to the yoke. The upper section 7 has an upper protrusion 101 extending downwardly from the upper section 7. The lower section 8 has a lower protrusion 102 extending upwardly from the lower section 8. The upper protrusion 101 includes a bearing surface 103 while the lower protrusion 102 includes a complementary surface 104.

The lower section 7 is curved and positioned within upper section 8 such that the lower section 7 can move with respect to upper section 8 without the distance between lower section 7 and upper section 8 changing significantly.

In use the bearing surface 103 of the upper protrusion 7 and the complementary surface 104 of the lower protrusion 8 interact to cause upper section 7 and lower section 8 to incline relative to one another upon application of pressure which is unbalanced about the castor pin to upper section 7 and lower section 8. The bearing surface 103 comprises a curved protrusion and may include a protective cover composed of, for example, nylon.

FIG. 11 shows the gradient device 5 in use in an apparatus 20, in this case a shopping trolley. When the trolley is moved in any direction the gradient device 5 acts to vary the angular displacement of the yoke axis 4 with respect to the castor axis 3 such that the wheel 80 is moved backward away from the direction of movement.

Although the present invention has been described with reference to the specific embodiments shown in the accompanying drawings, it will be understood that numerous modifications and variations are possible without departing from the scope of the invention.

1. A castor wheel assembly comprising:
a castor pin having a castor axis;
a yoke mounted to the castor pin and rotatable about a yoke axis;
a castor wheel rotatably mounted to the yoke about a wheel axis; and
a gradient device disposed between the castor pin and the yoke, the gradient device operative to allow angular displacement of the yoke axis relative to the castor axis, wherein the angular displacement of the yoke axis is variable with respect to the castor axis and occurs in more than one predetermined plane.

2. A castor wheel assembly as defined in claim 1, wherein the angular displacement of the yoke axis relative to the castor axis is restricted to the more than one predetermined plane.

3. A castor wheel assembly as defined in claim 1, wherein the direction of angular displacement of the yoke axis with respect to the castor axis is dependent upon the direction of motion of the castor wheel.

4. A castor wheel assembly as defined in claim 1 wherein the gradient device is operative to allow yoke axis to be raked with respect to the direction of movement of the castor wheel such that the rake of the yoke axis with respect to the direction of movement of the castor wheel is consistent within a predetermined angular range throughout the rotation of the yoke about the yoke axis.

5. A castor wheel assembly as defined in claim 1 wherein the predetermined plane contains the castor axis.

6. A castor wheel assembly as defined in claim 5, wherein the planes are angularly spaced about the castor axis by approximately 45°.

7. A castor wheel assembly as defined in claim 1, wherein the gradient device comprises an upper section mounted to the castor pin, the upper section having an upper protrusion extending downwardly from the upper section; and a lower section mounted to the yoke, the lower section having a lower protrusion extending upwardly from the lower section; wherein in use the upper protrusion and the lower protrusion interact.

8. A castor wheel assembly as defined in claim 7, wherein one of the upper protrusion and the lower protrusion comprises a bearing surface and the other of the upper and lower protrusion comprises a complementary surface.

9. A castor wheel assembly as defined in claim 8, wherein the bearing surface and complementary surface interact to cause the upper section and lower section to incline relative to one another upon application of a force which is unbalanced about the castor pin to the upper section and lower section.

10. A castor wheel assembly as defined in claim 8, wherein at the bearing surface has a hemispherical shape.

11. A castor wheel assembly as defined in claim 7, wherein the upper section and the lower section comprise U-shaped brackets.

12. A castor wheel assembly as defined in claim 11 wherein one of the upper section and the lower section includes one or more elongate apertures and the other of the upper section and the lower section includes one or more retaining bolts adapted to extend through the or each elongate aperture.

13. A castor wheel assembly as defined in claim 11, wherein the lower section includes two retaining bolts and the distance between the retaining bolts is approximately equal to the width of the upper section.

14. A castor wheel assembly as defined in claim 8, wherein the bearing surface comprises a bolt with a curved head and the complementary surface comprises a bolt with a flat head.

15. A castor wheel assembly as defined in claim 1, wherein the gradient device comprises:
an upper section mounted to the castor pin;
a lower section mounted to the yoke; and,
a coupler connecting the upper section and the lower section, wherein the coupler is operative to allow relative movement of the upper section and the lower section.

16. A castor wheel assembly as defined in claim 15, wherein the lower section and the upper section comprise U-shaped brackets.

17. A castor wheel assembly as defined in claim 15 wherein the upper section includes one or more elongate aperatures and the lower section includes on or more retaining bolts adapted to extend through the or each elongate aperature.

18. A castor wheel assembly as defined in claim 15, wherein the coupler comprises an biasing means operative to bias the sections into a first position, and wherein the threshold loading is required to overcome the bias of the biasing means to allow the sections to move from the first position so as to cause angular displacement of the yoke axis relative to the castor axis.

19. A castor wheel assembly comprising:
a chassis adapted to be rotatably mounted to an apparatus by means of the retaining pin;
a yoke rotatably mounted to the chassis;
a castor wheel mounted to a yoke by means of a castor wheel axle; and,
a support wheel mounted to the chassis by means of a support wheel axle, the support wheel being positioned to be unable to contact the castor wheel in use;
wherein the castor wheel leads the support wheel when the castor wheel assembly is rolled along a surface on the castor wheel and support wheel and wherein the retaining pin and the castor pin are substantially vertical in orientation.

20. A castor wheel assembly according to claim 19 wherein the castor wheel is offset in the primary direction of travel relative to the retaining pin when the assembly is rolled along the surface.

21. A castor wheel assembly according to claim 19, wherein the castor wheel and the support wheel are in alignment when the apparatus is rolled along a straight path.

22. A castor wheel assembly according to claim 19, wherein the yoke is attached to the chassis by a suspension attachment means.
